(19) United States
(12) Patent Application Publication
(10) Pub. No.: US 2007/0075499 A1
(43) Pub. Date: Apr. 5, 2007

(54) Housing for Seals, Preferably Radial Shaft Seals, and Method for Manufacturing such a Housing

(75) Inventors: Klaus-Jurgen Uhrner, Leingarten (DE); Roland Bleier, Muhlheim (DE)

Correspondence Address: GUDRUN E. HUCKETT DRAUDT, LONSSTR. 59, WUPPERTAL, 42289, DE

(73) Assignee: KACO GMBH + CO. KG, Heilbronn (DE)

(21) Appl. No.: 11/535,999

(22) Filed: Sep. 28, 2006

(30) Foreign Application Priority Data
Sep. 28, 2005 (DE) 10 2005 047 380.6
Sep. 20, 2006 (DE) 10 2006 046 414.1

(51) Int. Cl. F16J 15/34

(52) U.S. Cl. 277/354; 277/358

(57) ABSTRACT

A housing for a seal has a housing wall passing into a bottom that extends transversely to an axis of the housing. The bottom has a central opening through which a part to be sealed extends in the mounted position of the seal. The housing is a coil section that is cut from a coil having been wound from a metal part that is a metal strip.

### BACKGROUND OF THE INVENTION

The invention relates to a housing for seals, preferably radial shaft seals, comprising an outer wall that passes into a bottom extending transversely to the axis of the housing, wherein the bottom is provided with a central opening. The invention also relates to a method for manufacturing such a housing.

In radial shaft seals cup-shaped housings are used as a support member. Such a housing is comprised of metal and produced by deep-drawing. Such a manufacturing process is complex and expensive.

### SUMMARY OF THE INVENTION

It is an object of the present invention to configure a housing of the aforementioned kind and a method of the aforementioned kind such that the housing can be produced in a simple and inexpensive way.

In accordance with the present invention, this is achieved in connection with the housing in that the housing is a coil section of a coil that is wound from a metal part; the coil section is cut off the coil.

In accordance with the present invention, this is achieved in connection with the method in that the metal part is a metal strip wound to a coil, wherein a coil section is cut from the coil and the housing is made from the coil section.

The housing according to the invention is manufactured from a metal part that is wound to form a coil. A coil section is separated from the coil and from the coil section the housing is manufactured. The housing can be manufactured without producing any waste by using the metal part. For manufacturing the housing, an endless metal strip can be used that is wound to form a coil. From the coil, annular coil sections are separated from which the housing is manufactured. During the separating or cutting process, the winding process can be continued so that a very effective method is provided.

### BRIEF DESCRIPTION OF THE DRAWING

FIG. 1 shows an axial section of one half of a radial shaft seal in accordance with the present invention.

FIG. 2 is a perspective illustration of a tube that is produced by winding a sheet metal strip, wherein the tube is separated or cut into individual rings from which rings the housings for the radial shaft seal are produced.

FIG. 3 shows in section how a ring is produced from a metal part.

FIG. 4 shows in section a second method of producing a ring from a metal part.

FIG. 5 shows in axial section a housing with a bottom that has been formed on the housing by means of a rolling tool.

FIG. 6 shows an illustration in accordance with FIG. 5 of a second possibility of producing the bottom of the housing.

FIG. 7 shows in a perspective illustration a coil that is produced by winding a profiled-section sheet metal strip, wherein rings are cut or separated from the coil for producing housings for a radial shaft steel.

FIG. 8 shows a detail view of a section of the profiled-section sheet metal strip for producing the coil according to FIG. 7.

FIG. 9 is a perspective illustration of a housing that has been produced by cutting off a length of the coil according to FIG. 7 and welding it to a ring.

FIG. 10 is a detail view of a section of a profiled-section sheet metal strip of another embodiment.

FIG. 11 is a perspective illustration of the process of profiling a sheet metal strip to be used for producing the rings for the housing of a radial shaft seal.

FIG. 12 is a view of a tool for deforming a cylindrical ring to a housing for a radial shaft seal.

FIG. 13 is a section view along the section line XIII-XIII of FIG. 12.

FIG. 14 shows a second tool for deforming a cylindrical ring to a housing for a radial shaft seal.

FIG. 15 shows a section view along the section line XV-XV of FIG. 14.

FIG. 16 shows another tool for deforming a cylindrical ring to a housing for a radial shaft seal.

FIG. 17 is a section view along the section line XVII-XVII of FIG. 16.

FIG. 18 shows another tool for deforming a cylindrical ring to a housing for a radial shaft seal.

FIG. 19 is a section view along the section line XIX-XIX of FIG. 18.

### DESCRIPTION OF THE PREFERRED EMBODIMENTS

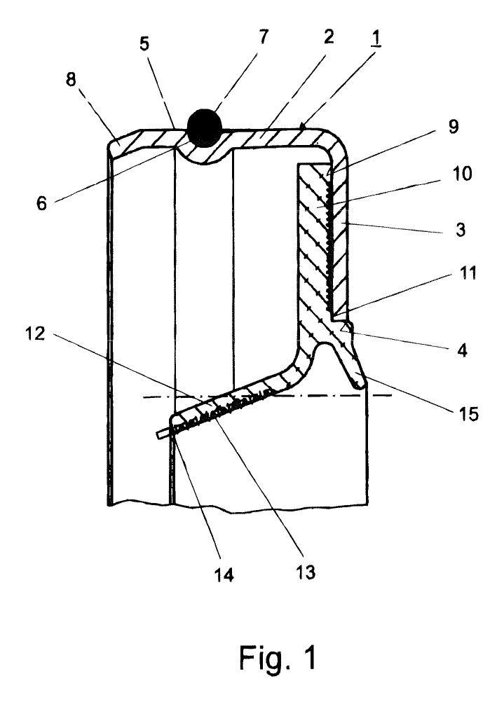

FIG. 1 shows a radial shaft seal with a cup-shaped housing 1 comprised of metal. It comprises a substantially cylindrical wall 2 which passes into a radially extending housing bottom 3. The bottom 3 is centrally provided with opening 4 through which a part to be sealed, preferably a shaft, passes. The housing wall 2 of the housing 1 has an annular groove 6 at its outer side 5; in cross-section, the annular groove 6 is of a part-circular shape. The groove 6 receives a static seal 7. The free end 8 of the housing wall 2 tapers conically in the radial inward direction.

On the inner side 9 of the housing bottom 3 a cover 10 is attached; it is advantageously glued to the inner side 9. The cover 10 extends approximately across the entire radial width of the housing bottom 3 and covers also the edge 11 of the central opening 4. The cover 10 passes into a sealing lip 12 that is of a conical shape and rests under radial pretension in its mounted state on the part to be sealed. The sealing lip 12 is provided at its inner side with a return conveying device 13 well known in the art of radial shaft seals. With such a device, medium that has escaped underneath the sealing edge 14 of the sealing lip 12 is returned.

At the level of the edge 11 of the opening 4, the cover 10 passes into a protective lip 15. The cover 10, the sealing lip 12, and the protective lip 15 form a unitary or monolithic part that is comprised, for example, of rubber or rubber-like material.

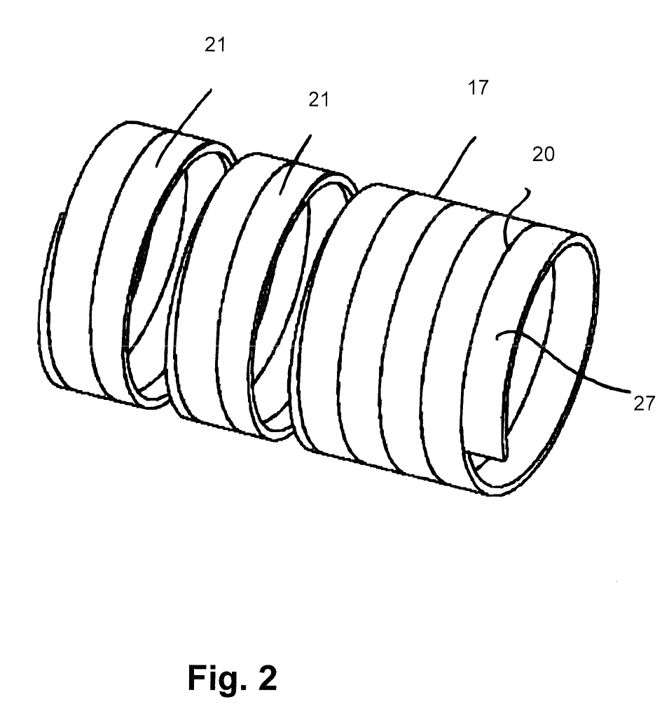

The housing 1 is produced in a way to be described in the following so as not to produce any waste; it can thus be manufactured inexpensively. As a starting material for the housing 1, a sheet metal strip 27 is used which according to FIG. 2 is wound to a tube 17. The edges of the wound sheet metal strip 27 that rest against one another are fused or welded to one another. Welding can be done by means of a laser, such as a CO₂ laser or a YAG laser, or can be done by a plasma welding process or a friction welding process The resulting welding seams 20 extends in a coil shape. Depending on the length of the sheet metal strip 27, tubes 17 of different length can be produced. In the case of tubes 17 of great lengths, coil sections in the form of cylindrical rings 21 are produced by radial cuts and the housings 1 are produced from such cylindrical rings 21.

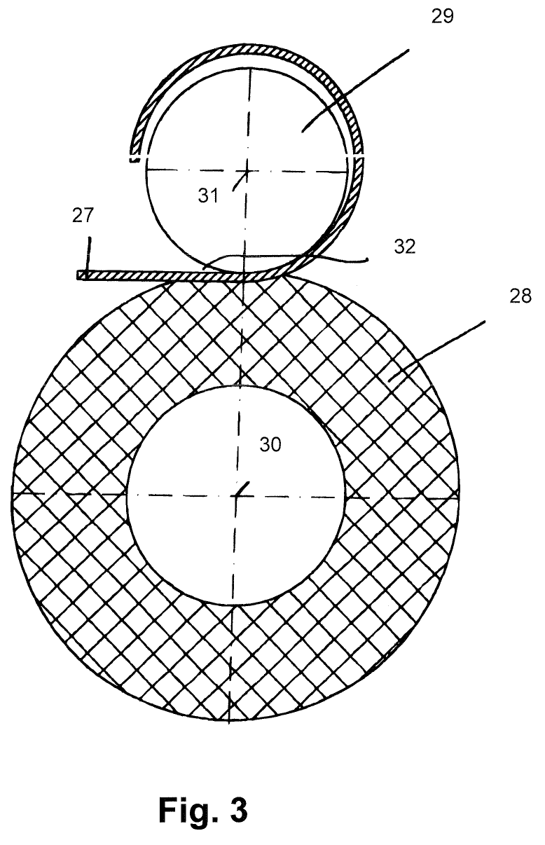

FIG. 3 shows one possibility of winding the sheet metal strip 27 to a tube 17. In this embodiment, two rolls 28, 29 are used; the roll 28 has a significantly greater outer diameter than the roll 29. At least the outer side of the roll 28 is configured to be elastically yielding. In the illustrated embodiment, the entire roll 28 is made of an elastically yielding material. In contrast to this, the roll 29 is made from metal. The roll 28 is driven in rotation. The sheet metal part 27 passes through the nip between the rolls 28, 29 and is bent to a tube 17 as it passes through the rolls. For this purpose, the two rolls 28, 29 rotate about their parallel axes 30, 31 wherein the roll 29 is entrained in rotation by friction. The sheet metal part 27, after leaving the roll nip 32 shown in FIG. 3, is bent to a tube 17. In this way, it is possible to form a cylindrical ring from a sheet metal strip.

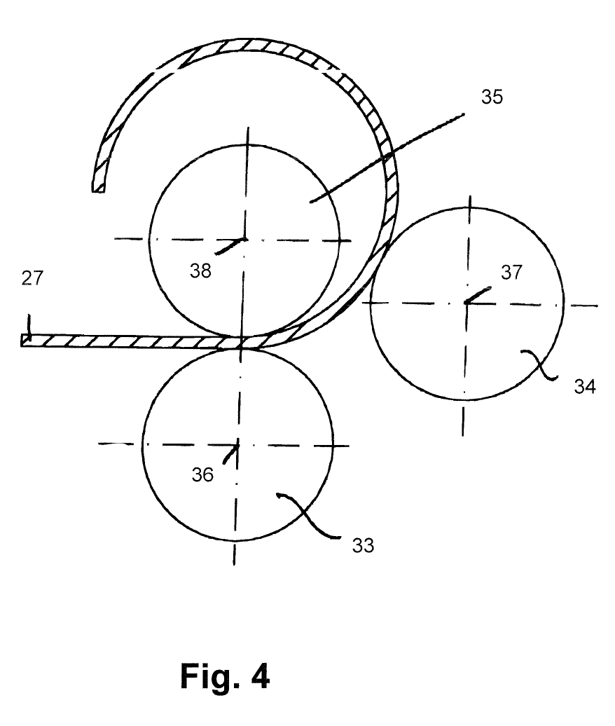

FIG. 4 shows the possibility of bending the sheet metal material 27 by means of three rolls 33, 34, 35 to a tube 17. The three rolls 33 to 35 have preferably the same diameter and are rotated during the bending process about parallel axes 36, 37, 38. The sheet metal material 27 passes through the nip between the two rolls 33, 35 that rotate in opposite directions relative to one another; at least one of the rolls 33, 35 is driven in rotation while the other roll is entrained. The sheet metal part 27 then reaches the roll 34 positioned at a spacing behind the rolls 33, 35 and the sheet metal material is deflected at the roll 34 for producing the tube 17. In order to achieve this, the axis of rotation 37 of the roll 34 has a smaller vertical spacing from the axis of rotation 38 than from the axis of rotation 36. The roll 34 is rotated such that the sheet metal material is bent like an arc in the direction toward the roll 35.

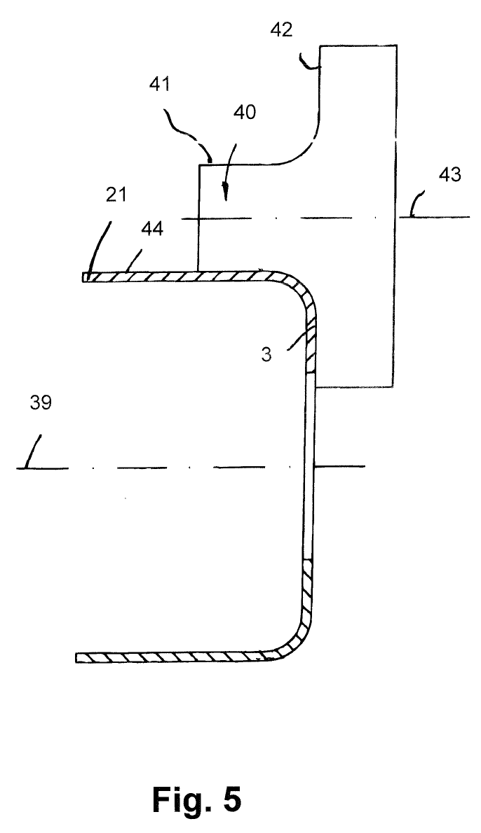

After welding the abutting edges of the sheet metal parts 27 and separating the rings 21 from the tube, the housing bottom 3 is produced by rolling. For this purpose, the rings 21 are pushed onto a mandrel so that they project past the end of the mandrel. In FIG. 5 only the axis of rotation 39 of the mandrel is shown. The rolling tool 40 has a cylindrical wall 41 that passes in an arc shape into a radial surface 42.

The rolling tool 40 is driven in rotation about its axis 43 which extends parallel to the axis of rotation 39 of the mandrel. During the rolling process, the ring 21 and the rolling tool 40 are moved relative to one another in the axial direction. This is realized such that the ring 21 and the rolling tool 40 are arranged relative to one another in such a way that the cylindrical wall 41 of the rolling tool 40 comes to rest against the exterior 44 of the ring 21. Upon relative displacement in the axial direction, the free end of the ring 21 reaches the arc-shaped transition between the cylindrical wall 41 and the radial surface 42. In this way, the free end of the ring 21 is bent radially inwardly in an arc shape. The radial surface 42 has a radial width that is greater than the radial width of the housing bottom 3. This ensures that the housing bottom 3 is formed properly on the ring 21 by this rolling process. During the rolling step, the mandrel receiving the ring 21 is entrained in rotation in the opposite direction. However, it is also possible to drive the mandrel in rotation. In this case, the rolling tool 40 is rotatingly entrained. Finally, the mandrel as well as the rolling tool 40 can be driven in rotation.

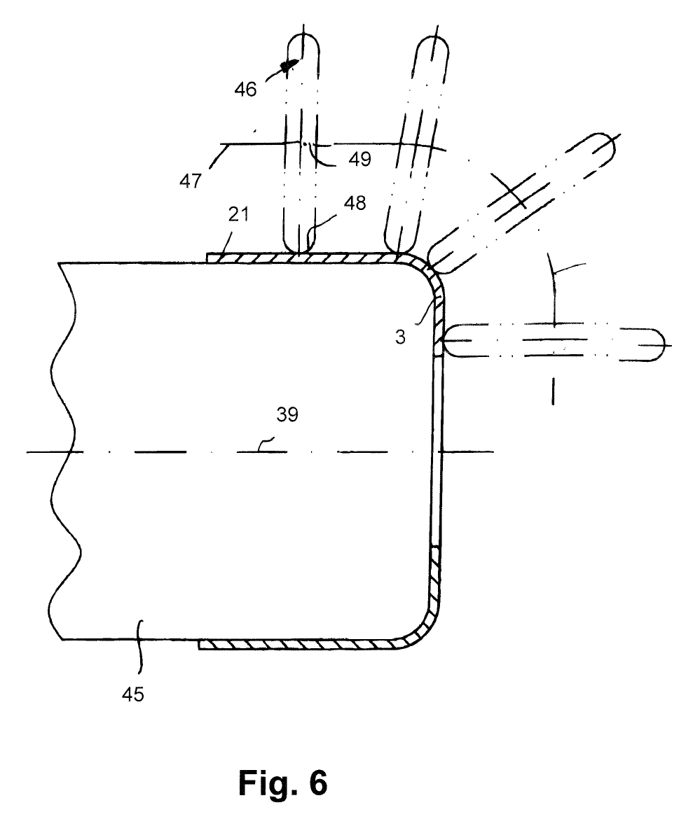

FIG. 6 shows a further possibility of forming the bottom 3 on the ring 21. The ring 21 is mounted on the mandrel 45 rotatable about axis 39 so that the part of the ring 21 to be formed into the bottom 3 projects axially past the mandrel 45. For bending the ring 21, a rolling roller 46 is provided which during the rolling process is moved along a path 47. The rolling roller 46 has a wall 48 that in radial section has the shape of a semi-circle; the wall 48 of the rolling roller 46 rests against the ring 21. During rolling, the mandrel 45 is rotatably driven about the axis 39 so that the rolling roller 46 will form the bottom 3 about the circumference of the ring 21. The rolling roller 46 first contacts the ring 21 at the end opposite the bottom 3 to be formed and is guided along the path 47 first axially along the ring 21. As soon as the rolling roller 46 reaches the part of the ring 21 projecting past the mandrel 45, this projecting part is bent inwardly in the radial direction so that the housing bottom 3 is formed. The path 47 extends in such a way that the rolling roller 46 produces the bottom 3 properly. The rolling roller 46 is advantageously driven in rotation about its axis 49 while moving along the path 47.

The described manufacture of the housing 1 by rolling reduces significantly the time-to-market time in comparison to conventionally produced housings. This time period for prior art seal housings is approximately five months. This time period is reduced to one day when producing a housing 1 by rolling. Also, the time for sample delivery from the time of ordering to the time of delivery to the customer is only one day for a housing 1 produced in accordance with the described manufacture by rolling. The rolling process does not require complex machinery and devices so that the seal housing can be produced very inexpensively. The manufacturing process does not produce noise. Also, no drawing aids as required in the case of the prior art housings are needed, i.e., the housings 1 must not be degreased after the rolling process. Also, it is possible to use material that has been pretreated for the manufacture of the housing 1 according to the invention. The manufacture essentially does not require part-specific tools. In particular, the sheet material 27 can be utilized to 100 percent so that no waste is produced. It is possible to produce structures on the ring 21, for example, by knurling. The rolling process does not produce any scoring marks on the housing 1 as they would be produced by drawing. On the housing 1, undercuts can be produced without any special means, for example undercuts like the annular groove 6 in the housing wall 2 or the insertion ramp 8 at the free end of the housing wall 2.

In the described embodiments, the bottom 3 of the housing 1 is generated by rolling or pressing. It is also possible to produce the bottom on the ring 21 by a drawing process.

In the embodiment according to FIG. 7, an L-shaped strip 16 is wound to form a coil 24. In contrast to the configuration according to FIG. 2, the windings 24′ of the coil 24 are spaced apart. The sheet metal strips 16 is first provided by rolling with an L-shaped profile. Subsequently, the profiled-section sheet metal strip 16 is bent to form a coil 24. Since the windings 24′ are spaced apart from one another, across the length of the wound coil 24 a buffer zone 25 is generated. This buffer zone ensures that the winding process must not be interrupted when the windings 24′ are cut to produce the required coil sections for making the rings 21. As a result of the spacing between the windings 24′, the winding process can be continued during the cutting process. The spacing between the windings 24′ is so great that the windings will not contact one another when cutting the coil sections from the coil for producing the ring. For example, the winding 24′ can be separated at the location 19. Since during the cutting action the coil 24 is continuously being wound, the residual windings 24′ will approach one another. As soon as the cut has been carried out, the spacing between the windings 24′ will be resiliently restored. The edges or end faces of the obtained open ring are then connected fixedly with one another, in particular by welding. This produces the ring 21 that forms the housing of the radial shaft seals.

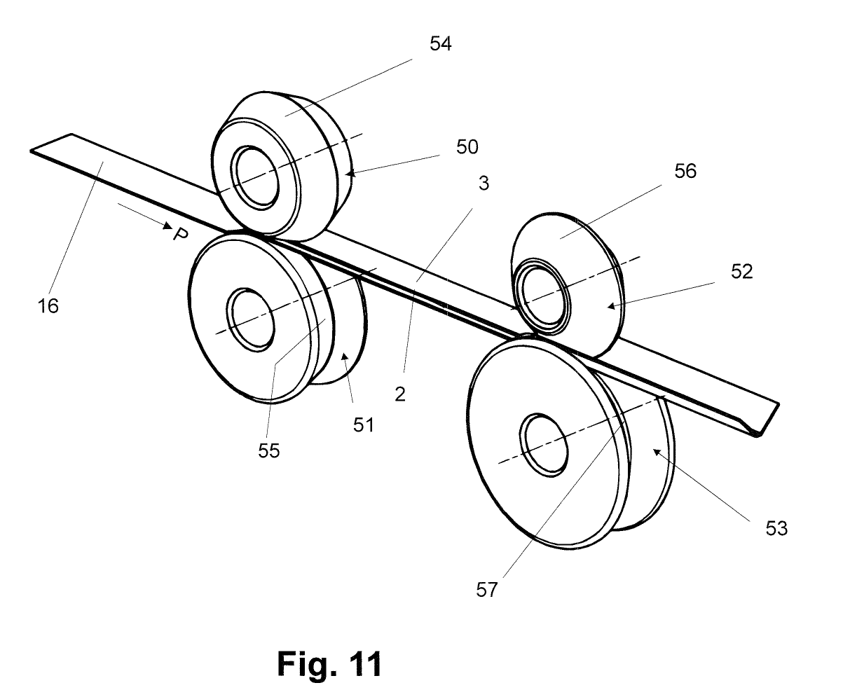

FIG. 11 shows a device for producing from a flat sheet metal strip 16 the profiled-section sheet metal strip according to FIG. 7. For this purpose, the flat sheet metal strip 16 passes through two roll pairs 50, 51 and 52, 53 between which, in two stages, the final L-shaped profile of the sheet metal strip 16 is formed. The rolls 50 to 53 are rotatably driven and have parallel axes of rotation. The two rolls 50, 51 between which the flat sheet metal strip 16 is first guided each have a conical wall 54, 55 whose axial width corresponds to the width of the profile part of the sheet metal strip 16 to be bent. Between the conical wall surfaces 54, 55, whose generators extend parallel to one another, the leg 2 is bent out of the flat sheet metal strip 16; this leg 2 forms the wall of the housing 1 of the radial shaft seal. In order to prevent overloading of the material of the sheet metal strip 16, the leg 2 is not yet bent completely out of the plane of the sheet metal strip 16 by the two rolls 50, 51. For this reason, the rolls 50, 51 have arranged downstream thereof the rolls 52, 53 that also have a conical wall 56, 57, respectively. The two conical wall surfaces 56, 57, whose generators also extend parallel to one another, are designed such that when the partially formed sheet metal strip 16 passes through them the leg 2 will be bent into its final position. After having passed through the second roll pair 52, 53, the sheet metal strip 16 has the required profile shape in order to be subsequently wound to coil 24 as explained above.

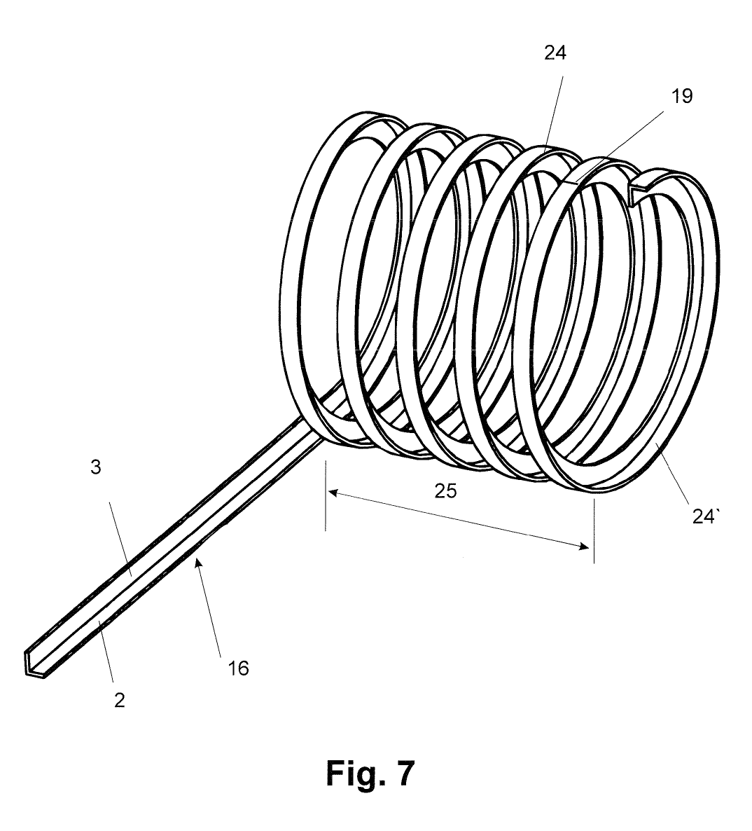

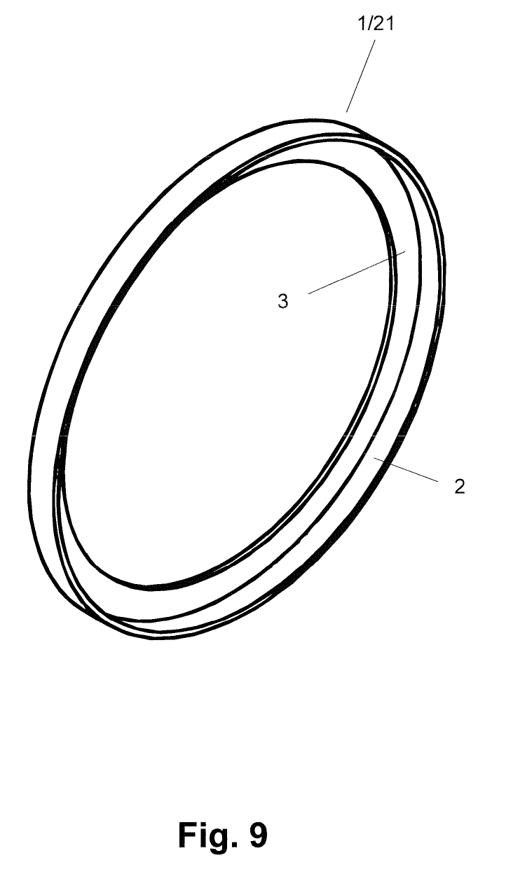

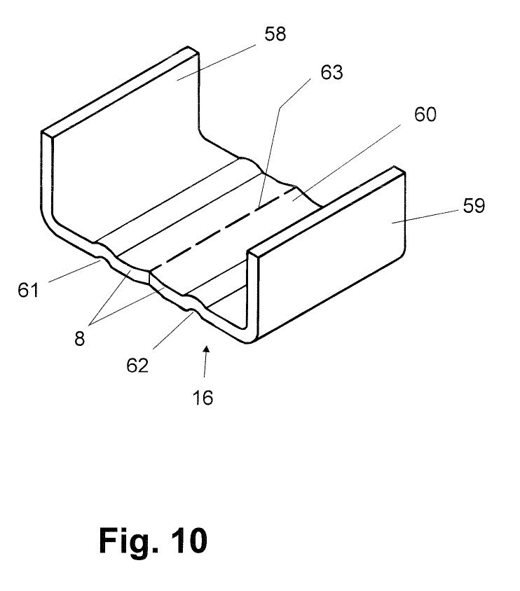

FIG. 10 shows a substantially U-shaped cross-section of a sheet metal strip 16. The sheet metal strip 16 is produced by rolling and has two parallel legs 58, 59 connected to one another by a web 60. The web 60 has on its outer side two recesses 61, 62 extending continuously across the length of the strip 16; the recesses 61, 62 have a part-circular cross-section and form later on the annular groove 6 in the housing wall 2 of the housing 1 of the radial shaft seal (FIG. 1). The strip 16 is separated at half the width of the web 60 in the longitudinal direction (separation line 63 in FIG. 10). In this way, two sheet metal strips 16 are formed that each have an L-shaped cross-section. One of these sheet metal strips is illustrated in FIG. 8. The leg 58 forms the housing bottom 3 in the future housing 1 as indicated by reference numeral 3/58; the remaining portion of the web 60 forms the wall 2 of the seal housing 1 as indicated by reference numeral 2/60. The recess 61 forms the annular groove 6 as indicated by reference numeral 6/61

Since the sheet metal strip 16 according to FIG. 10 is produced by rolling, the housing 1 for the radial shaft seal can be produced very inexpensively. The sheet metal strip, as has been explained in connection with FIG. 7, can be wound to form coil 24 from which the windings 24′ for producing the housing 21 are separated or cut. Since as a result of the rolling process, the rolled profile of the sheet metal strip 16 is provided with all shapes required for producing the housing 1, after producing the ring 21 no additional machining steps on the ring are required. It is therefore possible to attach directly thereafter the cover 10 with the sealing lips 12, 15 and the static seal 7.

It is also possible to produce the profiled section of the sheet metal strip 16 in accordance with FIG. 8 by rolling so that the separation process required in the case of the U-shaped sheet metal strip 16 according to FIG. 10 is not required.

The rolling process can also be used to generate the angled end 8 on the wall 2 of the housing 1 (FIGS. 8 and 10).

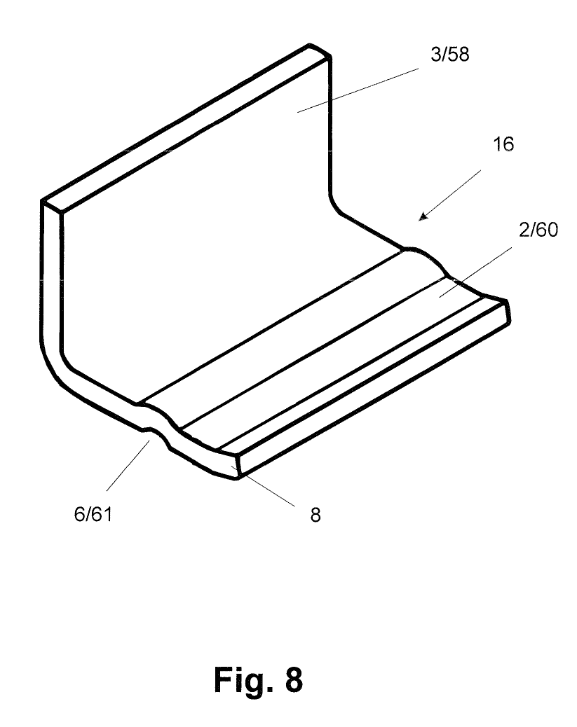

When windings of the coil 24 are separated from the coil and the separated ends of the windings are welded to one another, the ring 21 (FIG. 9) is formed that forms the housing 1 of the radial shaft seal. The thus produced housing 1 must not be processed further so that subsequently the cover 10 with the sealing lips 12, 15 and the seal 7 can be provided on the housing 1.

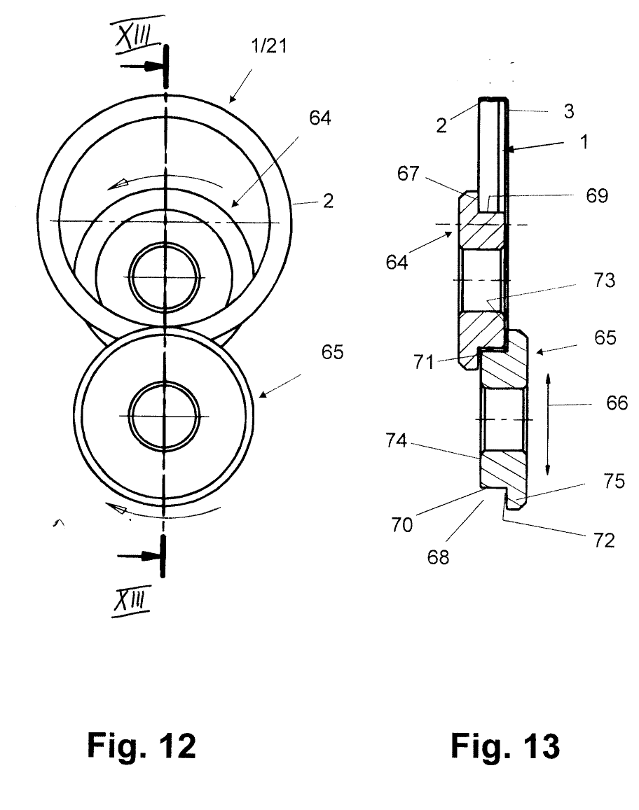

FIGS. 12 and 13 show a further possibility of deforming the cylindrical ring 21 to a housing 1. For this purpose, two rotatably driven rolls 64, 65 are used that are rotatable about parallel axes. The two rolls 64, 65 are rotatably driven in opposite directions to one another during the profiling process; this is indicated in FIG. 12 by the directional arrows. The roll 65 can be moved for insertion of the ring 21 transversely to its axis of rotation (double arrow 66 in FIG. 13). Both rolls 64, 65 have a circumferential recess 67, 68 in their outer wall surface. The recess 67 is radially delimited by a cylindrical surface 69 and the recess 68 by a cylindrical surface 70. The cylindrical surfaces 69, 70 are open at the end face of the rolls 64, 65 and adjoin the radial surfaces 71, 72.

The rolls 64, 65 are arranged relative to one another such that the cylinder surfaces 69, 70 are positioned at minimal spacing opposed to one another. The radial surfaces 71, 72 are positioned opposed to the end faces 73, 74 of the rolls 64, 65, respectively. As shown in FIG. 13, in this way an L-shaped gap is created between the cylindrical surfaces 69, 70 and the radial surfaces 71, 72 through which gap the cylindrical ring 21 is moved and formed to the housing 1. At the beginning of the forming process, the roll 65 is retracted so that its cylindrical surface 70 has a spacing from the cylindrical surface 69 of the roll 64. The two rolls 64, 65 are moved apart to such an extent that the cylindrical ring 21 that will form the housing 1 of the radial shaft seal after the forming process can be inserted into the space between the two rolls. The ring 21 is pushed so far onto the cylindrical surface 69 until its end face rests against the radial surface 71 of the roll 64. Subsequently, the roll 65 is moved in the direction toward the rolls 64. As soon as the part 75 of the roll 65 having the radial surface 72 engages the part of the cylindrical ring 21 that projects past the roll 64, this projecting part upon further movement of the roll 65 is bent radially inwardly for forming the bottom 3. The end face 73 of the roll 64 and the radial surface 72 of the roll 65 are spaced from one another by a spacing that matches the thickness of the bottom 3 of the ring 21. The rolls 64, 65 are moved relative to one another to such an extent that the spacing between their cylindrical surface 69, 70 corresponds to the thickness of the wall 2 of the ring 21. Since the rolls 64, 65 are driven in rotation, the ring 21 is rotated about its axis and, as this is being done, the bottom 3 is formed in the circumferential direction. As soon as the deformation of the ring 21 has been completed, the roll 65 is retracted in the direction of arrow 66 and the ring 21 that is now the formed housing 1 is removed. The next cylindrical ring can now be inserted and deformed in the described way. The device or the tool requires only minimal space because the two rolls 64, 65 are positioned directly adjacent to one another. The ring 21 to be deformed is moved between the two rolls 64, 65.

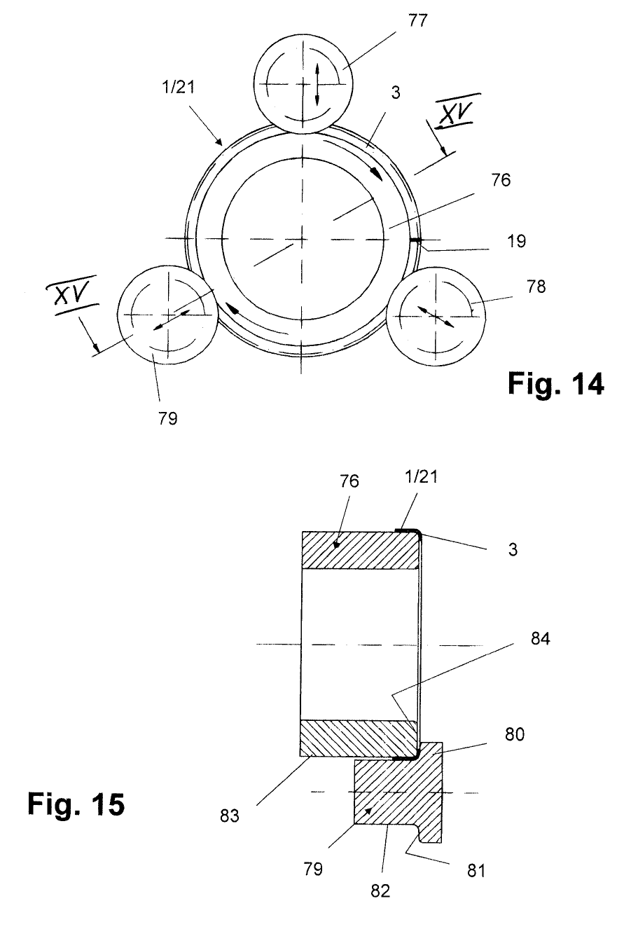

FIGS. 14 and 15 show a further embodiment of a tool with which the cylindrical ring 21 is formed to produce the housing 1. This tool has a central roll 76 that is driven in rotation. For deforming the cylindrical ring 21, the roll 76 interacts with three rolls 77 to 79 distributed about the circumference of the roll 76. The rolls 77 to 79 are radially movable relative to the central roll 76 and are rotatingly entrained during the deformation process by friction.

The rolls 77 to 79 are identical. They have at one end a radial outwardly oriented annular flange 80 (FIG. 15) whose inner radial surface 81 passes at a continuous curvature into a cylindrical wall surface 82. The curvature of the transition of the radial surface 81 into the cylindrical surface 82 corresponds to the curvature of the transition of the outer cylindrical surface 82 into the radial end face 84 of the central roll 76. The rolls 77, 78, 79 are arranged relative to the central roll 76 such that the radial flange 80 extends partially across the radial end face 84 of the roll 76. The outer diameter of the central roll 76 is significantly greater than the outer diameter of the rolls 77 to 79.

At the beginning of the deformation process, the rolls 77 to 79 are radially retracted so that the cylindrical ring 21 can be pushed onto the cylindrical surface 83. It is pushed onto the cylindrical surface 83 to such an extent that it projects axially past the radial end face 84 of the roll 76. This projecting part of the ring 21 is bent by the rolls 77, 78, 79 when radially advancing the rolls 77, 78, 79 toward the roll 76 in such a way that this part comes to rest against the end face 84 of the roll 76 (FIG. 15). This bent part of the ring 21 forms the bottom 3 of the housing 1 that is formed of the cylindrical ring 21. The central roll 76 and the outer rolls 77 to 79 that are arranged at an angular spacing of 120 degrees about the circumference of the roll 76 are arranged relative to one another such that the radial surfaces 81 of the flanges 80 of the rolls 77 to 79 are positioned opposite the radial end face 84 and the cylindrical surfaces 82 of the rolls 77 to 79 are positioned opposite the cylindrival surface 83 of the roll 76. In this way, the cylindrical ring 21 is engaged across its entire axial width by the rolls 76 to 79 during the deformation process so that a reliable deformation of the ring 21 to the housing 1 is ensured. FIG. 14 shows the cutting location 19 where the edges of the initial bent section of the sheet metal strip 16 are welded together. This tool, despite having four rolls 76 to 79, requires only minimal space so that the tool can also be used in the case of rather tight mounting spaces for deforming the cylindrical ring 21.

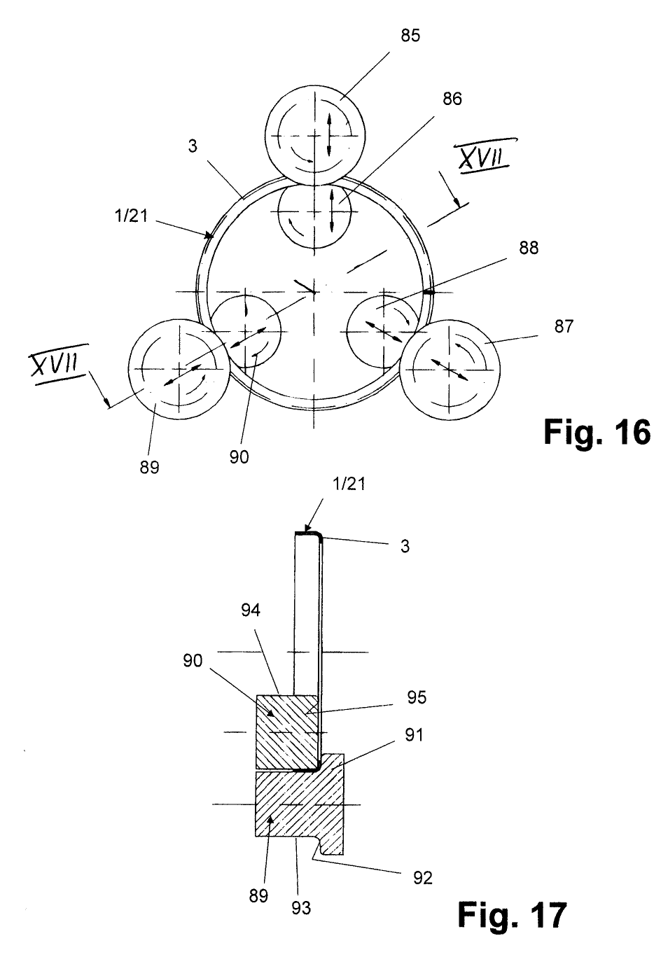

In the embodiment according to FIGS. 16 and 17, there are three roll pairs 85 86; 87, 88; 89, 90 provided that are positioned at an angular spacing of 120 degrees relative to one another. Between the roll pairs the cylindrical ring 21 to be deformed is inserted. The outwardly positioned rolls 85, 87, 89 are identical to the rolls 77 to 79 of FIGS. 14 and 15. Since the rolls 85, 87, 89 are identical, their configuration will be explained in connection with roll 89. Roll 89, like roll 79 according to FIG. 15, has at one end a radial outwardly projecting annular flange 91 having an inwardly positioned radial surface 92 that passes with a curvature into the cylindrical surface 93.

The radially inwardly positioned rolls 86, 88, 90 are also identical and will be explained in more detail with the aid of roll 90. The roll 90 has a cylindrical surface 94 that at one end face passes with a curvature into the radial end face 95. The configuration of the rolls 86, 88, 90 corresponds in principle to the configuration of the central roll 76 of the preceding embodiment. The roll pairs are correlated relative to one another such that the flange 91 of the radially outer rolls 85, 87, 89 passes partially across the radial end face 95 of the radially inner rolls 86, 88, 90 (FIG. 17).

The rolls of each roll pair are advantageously oppositely moveable in the radial direction so that the cylindrical ring 21 can be inserted between the rolls of the roll pairs, respectively. It is pushed onto the radial inner rolls 86, 88, 90 to such an extent that it projects past the end faces 95 of these rolls. When subsequently the rolls of the roll pairs are radially advanced toward one another, the part of the cylindrical ring 21 that projects axially past the rolls 86, 88, 90 will be deformed inwardly in the radial direction so that the bottom 3 of the housing 1 is formed. The rolls of the roll pairs are arranged relative to one another such that the ring 21 is positioned with its entire axial width between the rolls of the roll pairs. In this way, the bottom 3 is properly formed on the ring 21 so that the housing 1 for the radial shaft seal is produced. When the deformation process is terminated, the rolls 85 to 90 are radially moved apart and the housing 1 is removed.

In this embodiment, all rolls 85 to 90 are driven in rotation; the rolls of each roll pair are driven in opposite directions relative to one another. However, it is not necessary that all of the rolls are driven. The cylindrical ring 21 arranged between the rolls of the roll pairs is entrained in rotation about it axis by the roll pairs so that it is deformed about its circumference. This configuration, despite the use of six rolls 85 to 90, is also characterized by a compact configuration because the roll pairs are distributed about the circumference of the ring 21.

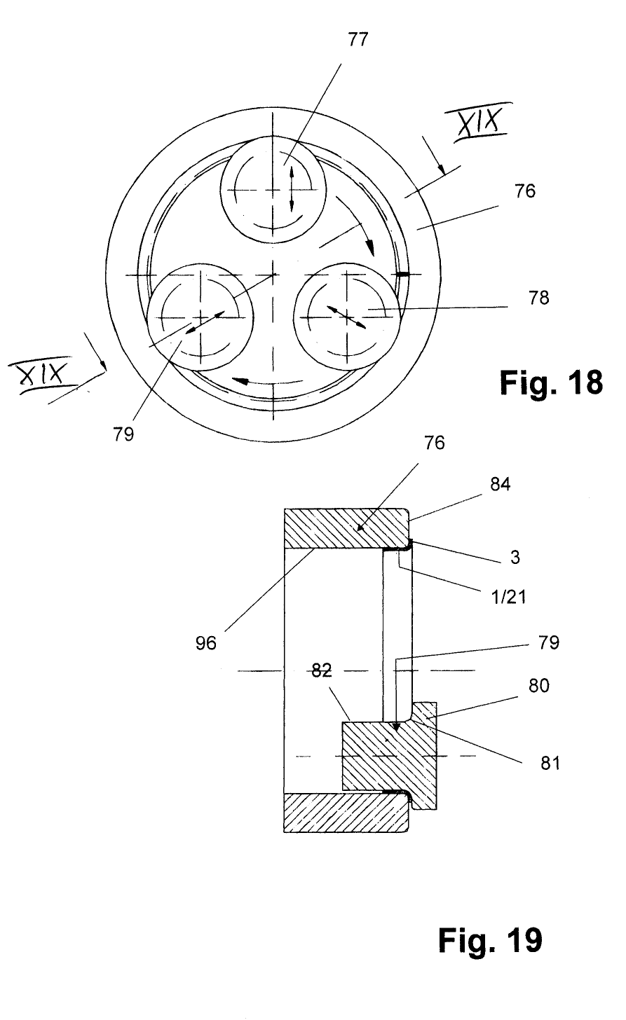

The embodiment according to FIGS. 18 and 19 differs from the embodiment of FIGS. 14 and 15 in that the rolls 77 to 79 are positioned radially inwardly and the central roll 76 extends partially across them in the radial direction. The rolls 77 to 79 have a radially outwardly oriented annular flange 80 whose inner radial surface 81 passes with continuous curvature into the cylindrical surface 82. In contrast to the embodiment according to FIGS. 14 and 15, the inner cylindrical surface 96 passes with a continuous curvature into the radial end face 84.

When the cylindrical ring 21 is to be deformed, the rolls 77 to 79 are radially inwardly moved so that the cylindrical ring 21 can be placed into the roll 76. The cylindrical ring 21 is positioned on the cylindrical surface 96 of the roll 76 and projects axially past it. Subsequently, the inner rolls 77 to 79 are moved outwardly in the radial direction so that, as the roll 76 rotates, the axially projecting part of the cylindrical ring 21 is deformed outwardly in the radial direction to the bottom 3 of the housing 1. The rolls 77 to 79 are arranged relative to the rolls 76 such that the rolls 77 to 79 project into the roll 76 and the radial flange 80 extend across end face 84 of the roll 76. The cylindrical surfaces 82 of the rolls 77 to 79 are positioned opposite the cylindrical surface 96 of the roll 76, and the radial surface 81 of the rolls 77 to 79 is positioned opposite the radial surface 84 of the roll 76. The transition from the radial surfaces and the cylinder surfaces is identical. In this way, it is ensured also that the cylindrical ring 21 is engaged across its axial length by the rolls 76 to 79 for its deformation.

Once the ring 21 has been deformed, the rolls 77 to 79 are moved inwardly in the radial direction to such an extent that the finish-shaped housing 1 can be removed from the roll 76 and the next cylindrical ring 21 can be inserted. As in the embodiment of FIGS. 14 and 15, only the rolls 76 is driven in rotation while the rolls 77 to 79 are rotatingly entrained during the deformation process. This embodiment is also characterized by its constructive simplicity and its minimal space requirement.

The specification incorporates by reference the entire disclosure of German priority documents 10 2005 047 380.6 having a filing date of 28 Sep. 2005 and (application number not yet known) having a filing date of 20 Sep. 2006.

While specific embodiments of the invention have been shown and described in detail to illustrate the inventive principles, it will be understood that the invention may be embodied otherwise without departing from such principles.

What is claimed is:

1. A housing for a seal, the housing comprising:
a housing wall passing into a bottom that extends transversely to an axis of the housing, wherein the bottom has a central opening;
wherein the housing is a coil section that is cut from a coil having been wound from a metal part.

2. The housing according to claim 1, wherein abutting edges of the coil section are welded together.

3. The housing according to claim 2, therein the abutting edges are positively connected to one another.

4. The housing according to claim 2, wherein the abutting edges extend parallel to the housing axis within the housing wall.

5. The housing according to claim 2, wherein the abutting edges extend in a coil shape within the housing wall.

6. The housing according to claim 1, wherein the metal part is a metal strip.

7. The housing according to claim 6, wherein the metal strip is profiled.

8. The housing according to claim 7, wherein the metal strip is L-shaped.

9. A method for producing a housing according to claim 1, the method comprising the steps of:
winding a metal strip to a coil;
separating a coil section from the coil;
forming the coil section to a housing.

10. The method according to claim 9, wherein in the step of winding a tube is produced.

11. The method according to claim 10, further comprising the step of welding abutting edges of windings of the metal strip together.

12. The methods according to claim 11, wherein, in the step of welding, a CO₂ laser or a YAG laser is used.

13. The method according to claim 11, wherein, in the step of welding, a plasma welding process or a friction welding process is used.

14. The method according to claim 10, wherein, in the step of separating, cylindrical rings are cut radially from the tube.

15. The method according to claim 14, wherein the cylindrical ring is deformed to form the housing.

16. The method according to claim 15, wherein the cylindrical ring is deformed by at least a first roll and a second roll between which first and second rolls the cylindrical ring is deformed.

17. The method according to claim 16, wherein at least the first roll is driven in rotation.

18. The method according to claim 15, wherein the cylindrical ring is deformed by a first roll that is arranged centrally and at least two second rolls that are arranged about a circumference of the first roll.

19. The method according to claim 18, wherein the first roll is rotatably driven.

20. The method according to claim 18, wherein the at least two second rolls are positioned outside of the first roll or partially inside the first roll.

21. The method according to claim 18, wherein the at least two second rolls are radially movable relative to the first roll.

22. The method according to claim 15, wherein at least two roll pairs are arranged on an imaginary circle extending about an axis of the cylindrical ring to be deformed.

23. The method according to claim 22, wherein the cylindrical ring is positioned between first and second rolls of each of the at least two roll pairs.

24. The method according to claim 23, wherein at least the first roll of each of the at least two roll pairs is adjustable relative to the second roll transversely to an axis of rotation of the second roll.

25. The method according to claim 15, wherein the cylindrical ring is deformed by first and second rolls that have different diameters.

26. The method according to claim 25, wherein one of the first and second rolls is a metal roll.

27. The method according to claim 25, wherein one of the first and second rolls has an outer wall that is elastically yielding.

28. The method according to claim 9, wherein windings of the coil are spaced apart from one another.

29. The method according to claim 28, wherein the windings of the coil form a buffer zone for the step of separating.

30. The method according to claim 28, wherein the coil section is an open ring cut from windings of the coil, wherein the open ring has edges and the edges are fixedly connected to one another to form a cylindrical ring.

31. The method according to claim 9, wherein the step of separating is carried out while the step of winding is continued.
